(19) United States
(12) Patent Application Publication
(10) Pub. No.: US 2010/0140230 A1
(43) Pub. Date: Jun. 10, 2010

(54) METHOD FOR THE MANUFACTURE OF A WELDED ROTOR FOR A GAS-TURBINE ENGINE

(75) Inventors: Karl SCHREIBER, Am Mellensee (DE); Kim GROSSMANN, Trebbin (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/629,447

(22) Filed: Dec. 2, 2009

(30) Foreign Application Priority Data
Dec. 4, 2008 (DE) 10 2008 060 205.1

(51) Int. Cl. B23K 15/00; B23K 31/02

(52) U.S. Cl. 219/121.14; 228/176

(57) ABSTRACT

With a method for manufacturing welded rotors for a turbine, especially a gas-turbine engine, in which two or more rotor disks are joined to each other by conventional welding processes using welds extending radially to the rotor axis and the weld zone is subsequently thermally treated at a certain temperature to relieve residual tensile stresses by relaxation, the weld is set to a significantly lower non-relaxatory temperature level than the heat-affected zone adjoining the weld so that, as a result of the high temperature gradient, a residual compressive stress or at least a substantially reduced residual tensile stress is impressed on the weld. Compared to conventionally heat treated and welded rotors, improved strength properties in the weld zone and an increased service life are obtained as a result of the reduced tensile stresses.

This application claims priority to German Patent Application DE102008060205.1 filed Dec. 4, 2008, the entirety of which is incorporated by reference herein.

This invention relates to a method for the manufacture of a welded rotor for a turbine, especially a gas-turbine engine, in which two or more rotor disks are joined to each other by conventional welding processes using welds extending radially to the rotor axis and the weld zone is subsequently thermally treated to relieve residual tensile stress.

The compressors and turbines of a gas-turbine engine each include several rotor wheels joined to each other to form a rotor (rotor drum) and rotating with high speed around an engine axis, with the rotor wheels having a rotor disk with rotor blades extending radially from the periphery thereof. Besides threadedly connected rotors, weldedly joined rotors have long been known in which directly adjoining rotor disks are connected to each other along their mutual contacting surfaces by a weld produced by conventional welding processes. The advantages of the weld joint over the threaded connection are weight saving, reduced strength loss and more favorable force flow, as well as freedom of design. Welding processes preferably used for joining the individual rotor disks are electron-beam welding as well as friction welding. Alternative welding processes are laser, ultrasonic, induction, inert-gas or electric-arc welding, just to name a few. The electron-beam welding process is advantageous in that its high energy density ensures deep penetration into the material and the welding stresses therewith produced as well as the resultant hazard of distortion of the weldment are comparatively low. However, the welding action destroys the microstructure of the base material in the heat-affected zone bilaterally adjoining the weld metal by formation of fine grain or coarse grain, respectively, and partial structural transformation or precipitation of phases in the grain and at the grain boundaries, respectively. Another weak point with electron-beam welding is weld overlap at the starting and at the end point and the discontinuities associated therewith.

Furthermore, another essential problem is shrinkage due to cooling of the weld metal and the circumferential residual tensile stress in the weld resulting therefrom. This region of worst material quality and impaired mechanical properties is highly loaded in operation, i.e. during rotation of the welded rotor at high speed, so that the stress in the weld zone is additionally significantly increased. In order to limit the impairment of strength and the resultant reduction of service life of the welded rotor associated with structural transformations and precipitations in the heat-affected zone as well as the residual tensile stresses in the weld, it is known to subject the rotor to a post-weld heat treatment in which the strength-reducing weld structure in the heat-affected zone is eliminated and the residual tensile stresses in the weld zone are reduced. However, even after heat treatment, the tensile stresses, both at standstill of the engine and—even more—during rotation of the rotor in operation of the engine, are still high enough to impair the service life of the welded rotor.

In a broad aspect, the present invention provides a method for the manufacture of welded rotors featuring improved strength properties in the weld zone and long service life.

On the basis of the known methods for the manufacture of welded rotors for gas-turbine engines, in which the weld zone is exposed to a post-weld heat treatment at a certain temperature (Trelaxation) to relieve residual tensile stresses by relaxation, the present invention in its essence provides that, during heat treatment, the temperature of the weld is decreased to a significantly lower, non-relaxatory temperature level (Tweld<<Trelaxation) than the heat-affected zone adjoining the weld so that, as a result of the high temperature gradient, residual compressive stress, or at least substantially reduced residual tensile stress, is impressed on the weld, thereby considerably improving the strength properties in this operationally highly loaded weak point and increasing the service life of the rotor so produced. Moreover, the heat treatment according to the present invention can also be performed on non-welded circumferential rotor areas subject to very high circumferential tensile stresses, to significantly lower the tensile stresses there, and, if applicable, also the compressive stresses.

In a further embodiment of the present invention, initially the entire region of the heat-affected zone and of the weld is heat treated at a temperature relieving residual tensile stress (Trelaxation) and subsequently only the bilaterally heat-affected zone, which is shielded on both-sides, is further heat treated at the same temperature (Trelaxation) while cooling the weld to the lower temperature level (Tweld).

Cooling of the weld and heating of the weld-adjoining region is accomplished by use of at least one coolant jet and at least one heating jet. The heating jet and the coolant jet are shielded from the respective adjacent area by shielding plates, thereby effectively obtaining a high thermal gradient towards the weld. The coolant jet and the heating jet are positioned offset to each other. For uniform heating or cooling, respectively, the coolant jet and the heating jet are continuously moved along the weld zone over a period of time lasting from a few minutes up to several hours depending on the external conditions (rotor design, rotor material, welding parameters), actually in particular by rotation of the rotor around its longitudinal axis at a rotational speed producing a homogenous circumferential temperature field and again being dependent on the external conditions.

In development of the present invention, the coolant jet is produced by compressed air and the heating jet by a gas flame—preferably provided by an acetylene burner.

In an advantageous development of the idea underlying the present invention, which is characterized by the generation of a thermal gradient in the weld zone, initially the entire area of the heat-affected zone and of the weld can be heat treated at a temperature relieving residual tensile stresses (Trelaxation) and subsequently only the weld cooled to the lower temperature level (Tweld). In this case, the additional heat radiators in the heat-affected zone are dispensable, with just the weld being cooled by at least one coolant jet, preferably in the form of compressed air, shielded towards the adjoining areas and moved continuously along the weld.

During cooling treatment, the rotor is again rotated at a speed ensuring uniform temperature in the circumferential direction of the weld.

In yet another advantageous development of the underlying idea of the present invention, which is heat treatment with high thermal gradient, solely the area bilaterally adjoining the weld is heated immediately upon welding, i.e. while still being in the welding apparatus, by the concentrated energy of a welding beam moving continuously relative to the rotor to impress, by virtue of the resultant temperature gradient, residual compressive stress on the weld, thereby improving the strength properties in the weld zone. For introduction of concentrated energy exclusive of the weld, heating is preferably accomplished by an electron beam. Uniform heating of this area is ensured by continuous rotation of the rotor around its longitudinal axis.

For controlling the temperatures produced in the weld zone, a thermal imaging camera pointing at the weld zone is provided. Temperature is controllable by appropriately setting the coolant and heat radiators as well as in dependence of the rotational speed of the rotor.

Provided that the rotor disks to be welded to each other are made of a Ni or Ti-base forging material, the heat treatment temperature (Trelaxation) can, in accordance with the respective residual stress profile, range between 700° C. and 800° C., with the temperature of the cooled weld (Tweld) being set approx. 150° C. lower to produce the thermal gradient.

The present invention can be applied on the basis of a multitude of conventional welding processes. Preferably, the abutting rotor disks are joined to each other by electron-beam welding. This type of heat treatment, which is based on the generation of a high temperature gradient, is advantageous also in non-welded rotor areas with very high circumferential tensile stresses.

The present invention is more fully described in light of the accompanying drawing showing a preferred embodiment. In the drawing,

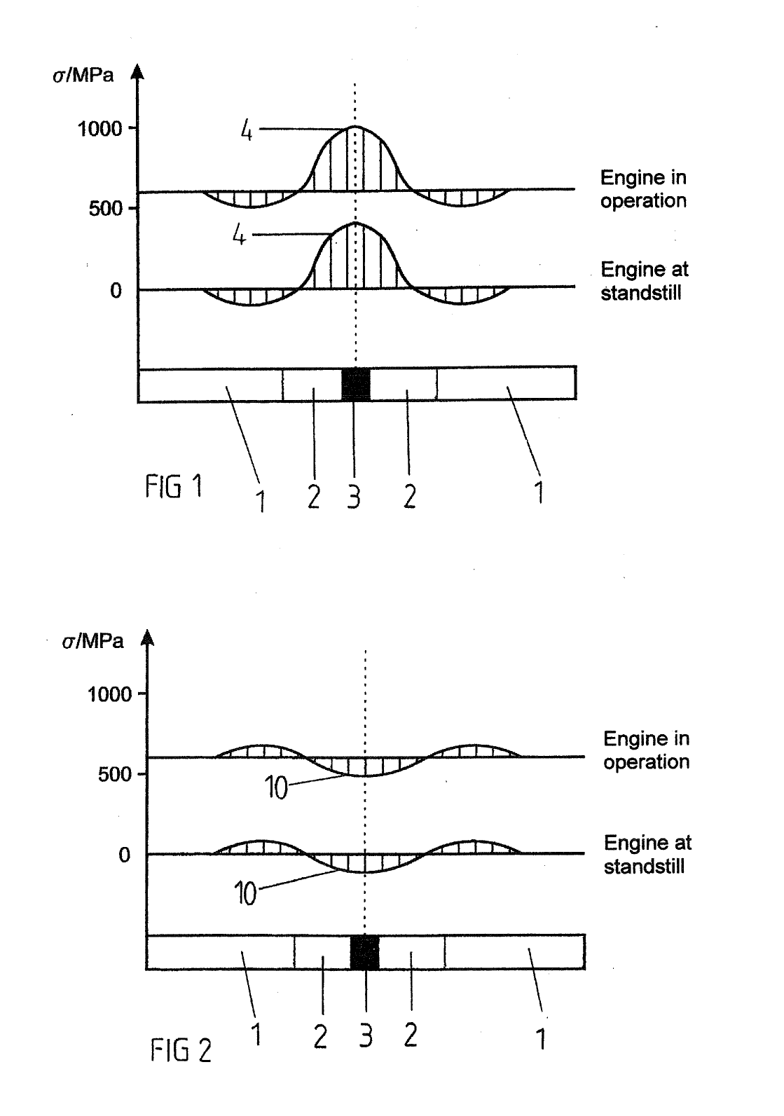

FIG. 1 is a graphical representation of the stress distribution in the weld zone on a rotor heat-treated in accordance with the state of the art without temperature gradient,

FIG. 2 is a graphical representation of the stress distribution on a welded rotor manufactured in accordance with the present invention, and

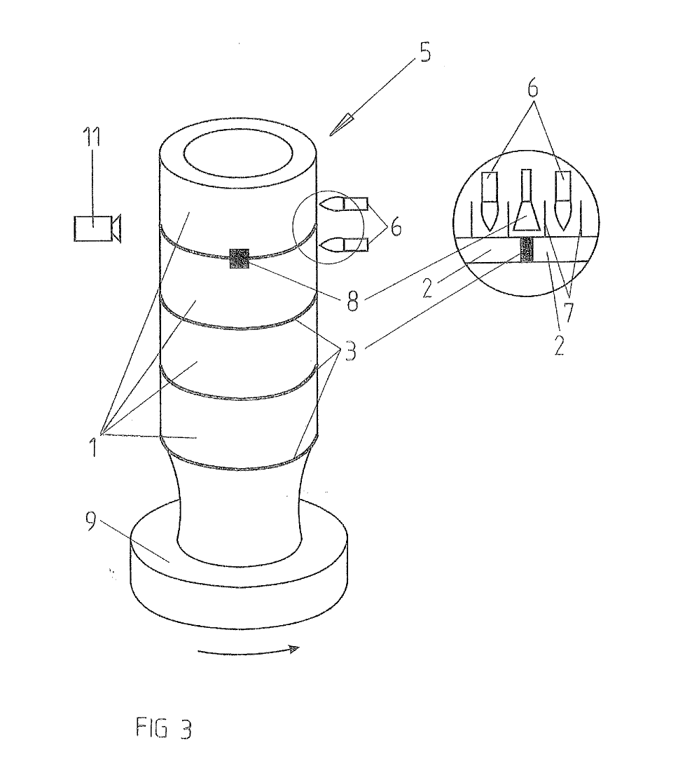

FIG. 3 is a schematic representation of an apparatus for weld heat treatment on a rotor made of several rotor disks welded to each other.

FIG. 1 shows the stress distribution across two rotor disks 1 joined to each other by electron-beam welding in the region of the weld 3 and the zone adjoining the latter on both sides. The forged rotor disks 1 are made of a high temperature-resistant nickel-base forging material, in the present example INCO 718. Heat treatment according to the state of the art performed after welding at 760° C. for four hours (PWHT: post-weld heat treatment) precludes precipitation of brittle phases in the grain and at the grain boundaries in the heat-affected zones 2 adjoining the weld 3. Furthermore, post-weld heat treatment (PWHT) enables the residual tensile stress indicated by reference numeral 4 to be reduced in the region of the weld 3 from approx. 800 MPa to a value of 395 MPa. In operation of the engine, the stress distribution in the weld zone is however raised by the high centrifugal forces to the upper level shown in FIG. 1, so that the maximum value of residual tensile stress will amount to approx. 1000 MPa. This means, however, that the residual tensile stress 4 in the weld zone is still very high and the service life of the welded rotor 5 so produced is accordingly low.

Therefore, the welded rotor 5 heat treated according to the above PWHT process is subsequently subjected to a further heat treatment in which the rotor 5, being set up on a rotary table 9 and therefore rotating around its longitudinal axis, is heated by a heat radiator 6, in the form of a gas burner, to 760° C. in only a locally confined area adjoining the weld 3 whose respective width is approximately twice the material thickness or the respective width of the heat-affected zone 2. Shielding of the respective heat jet (of the gas flame of the gas burner) to both sides is accomplished with shielding elements 7, so that actually only the areas adjoining the weld 3 are heated and stresses relieved in the process by relaxation and plastification. Simultaneously, the weld 3 is cooled by a 90°-offset coolant radiator 8 (compressed-air radiator) and thereby held at a temperature of 610° C., so that, as shown in FIG. 2, the residual stress profile is reversed by applying temperature conditions which are reverse to those in the welding process, i.e. cooler weld zone and hotter bilaterally adjoining heat-affected zone 2, and residual compressive stresses 10 are produced in the weld 3 and the stress level in general is substantially reduced in the weld zone. This means that the stress situation in the highly loaded weld zone is changed and relieved also in the operating condition of the engine, thereby obtaining a substantial increase in service life of the engine rotors.

The duration of the second heat treatment, which is confined to a narrow region adjoining the weld with separate cooling of the weld 3, i.e. with high thermal gradient between the weld 3 and the region adjoining thereto (heat-affected zone 2), is about 30 minutes in the present example.

As mentioned in the above, local heat treatment or cooling, respectively, of the weld zone is accomplished during rotation of the rotor 5, i.e. the weld 3, to ensure uniform introduction of heat with negligibly small temperature gradient in the circumferential direction. For this purpose, the welded rotor 5 is set in rotary motion before the weld zone is heat treated/cooled. The rotational speed of the rotor 5 is about 2 revolutions per second in the present example. The temperature setting in the heat treatment/cooling zone, which is controllable via the heat radiators 6 and the coolant radiators 8 as well as the rotational speed of the rotary table 9, is inspected by a thermal imaging camera 11 pointing at the respective weld zone of the rotor 5.

The present invention is not limited to the above example. Depending on the material and the design of the rotor 5 as well as the respective welding parameters, the rotational speed may range between 1 and 10 revolutions per second and the heat treatment performed with high thermal gradient can have a duration between some minutes and several hours, with the heat treatment/cooling of course being carried out at temperatures adjusted to the respective material. Besides the gas burners (heat radiators), compressed-air radiators (coolant radiators) and shielding plates, other heating, cooling and shielding mechanisms can also be used to obtain the temperature gradient dropping at the weld and the compressive stresses therewith produced in the weld. For example, annular heat radiators arranged on both sides of the weld 3 can also be provided in lieu of individual heat radiators.

In a first variant, solely a cooling of the weld 3 is performed in the above manner immediately upon the known post-weld heat treatment of the entire weld zone, i.e. without further supply of heat at the edge of the weld, to thereby impress compressive stresses on the weld.

In another variant of the method for decreasing the temperature of the weld 3 below that of the weld-adjoining edges (heat-affected zone 2) on the two joined rotor disks 1, and thereby impressing compressive stresses on the weld 3, only the weld-adjoining edge areas of the joined rotor disks 1 are, immediately upon welding, i.e. while still being in the welding apparatus, heated by an electron beam—here also used for the production of the weld. Since the high thermal gradient between the edge areas of the rotor disks and the weld is reverse to that of the welding process, residual compressive stress is impressed on the weld, thereby enhancing the durability of the weld joint between the rotor disks and increasing the service life of the rotor.

The above variants have been described on the basis of electron-beam welding. Of course, the present invention is also applicable in conjunction with other welding processes suitable for joining the disks of engine rotors.

### LIST OF REFERENCE NUMERALS

1 Rotor disks
2 Heat-affected zone
3 Weld
4 Residual tensile stress after conventional heat treatment
5 Rotor
6 Heat radiator, gas burner
7 Shielding element, shielding plate
8 Coolant radiator, compressed-air radiator
9 Rotary table
10 Residual compressive stress
11 Thermal imaging camera

What is claimed is:

1. A method for manufacturing a welded rotor for a turbine, comprising:
welding at least two rotor disks to each other using welds extending radially to a rotor axis;
subsequently thermally treating the weld zone at a certain temperature (Trelaxation) to relieve residual tensile stresses by relaxation;
wherein, during the thermal treatment, the weld is set to a significantly lower non-relaxatory temperature level (Tweld <<Trelaxation) than the heat-affected zone adjoining the weld so that, as a result of the high temperature gradient, at least one of substantially reduced residual tensile stresses and residual compressive stresses, are impressed on the weld.

2. The method of claim 1, and further comprising initially heat treating an entire region of the heat-affected zone and of the weld at a temperature relieving residual tensile stress (Trelaxation) and subsequently further heat treating only the bilaterally heat-affected zone, which is shielded on both-sides, at the same temperature (Trelaxation) while cooling the weld to the lower temperature level (Tweld).

3. The method of claim 2, and further comprising cooling the weld with at least one coolant jet and heating the weld-adjoining region with at least one heating jet, which are shielded from the respective adjacent area(s), with the coolant jet and the heating jet being continuously moved along the weld zone.

4. The method of claim 3, and further comprising positioning the coolant jet and the heating jet offset to each other.

5. The method of claim 3, and further comprising the coolant jet with compressed air and the heating jet with a gas flame.

6. The method of claim 3, and further comprising setting the rotor in continuous rotary motion during heat treatment.

7. The method of claim 6, and further comprising setting the rotational speed of the rotor to lie in a range producing a homogenous circumferential temperature field.

8. The method of claim 1, and further comprising initially heat treating an entire region of the heat-affected zone and the weld at a temperature relieving residual tensile stresses (Trelaxation) and subsequently cooling only the weld to the lower temperature level (Tweld).

9. The method of claim 8, and further comprising cooling the weld with at least one coolant jet shielded from the adjacent areas and continuously moved along the weld.

10. The method of claim 10, and further comprising, during cooling treatment, rotating the rotor at a speed ensuring uniform temperature in a circumferential direction of the weld.

11. The method of claim 10, and further comprising producing the coolant jet with compressed air.

12. The method of claim 1, and further comprising heating solely an area adjoining the weld immediately upon welding with concentrated energy of a welding beam moving continuously relative to the rotor to impress, by virtue of a resultant temperature gradient, at least one of residual compressive stress and highly reduced residual tensile stress on the weld.

13. The method of claim 12, and further comprising continuously rotating the rotor around its longitudinal axis during heating by the welding beam.

14. The method of claim 12, wherein the welding beam is an electron beam.

15. The method of claim 1, wherein the rotor disks to be welded to each other are made of at least one of Ni and Ti-base forging material, with the heat treatment temperature (Trelaxation) ranging, in accordance with a respective residual stress profile, between 700° C. and 800° C., and a temperature of the cooled weld (Tweld) being set about 150° C. lower to produce the thermal gradient.

16. The method of claim 1, and further comprising joining abutting rotor disks to each other by electron-beam welding.
